(19) United States
(12) Patent Application Publication
(10) Pub. No.: US 2017/0145354 A1
(43) Pub. Date: May 25, 2017

(54) LIQUID DETERGENT COMPOSITIONS AND THEIR MANUFACTURE

(71) Applicant: BASF SE, Ludwigshafen (DE)

(72) Inventors: Catherine BREFFA, Mannheim (DE); Alejandra GARCIA MARCOS, Ludwigshafen (DE); Ann-Kathrin MARGUERRE, Mannheim (DE)

(73) Assignee: BASF SE, Ludwigshafen (DE)

(21) Appl. No.: 15/323,889

(22) PCT Filed: Jul. 7, 2015
(86) PCT No.: PCT/EP2015/065428

§ 371 Date: Jan. 4, 2017

(30) Foreign Application Priority Data
Jul. 17, 2014 (EP) 14177481.0

(51) Int. Cl. C11D 11/00; C11D 1/29; D06F 35/00; C11D 1/22; C11D 1/72; C11D 3/20; C11D 3/33; C11D 1/83

(52) U.S. Cl. CPC C11D 11/0017; C11D 3/33; C11D 1/29; C11D 1/83; C11D 1/22; C11D 1/72; C11D 3/2075; D06F 35/006

(57) ABSTRACT

The present invention is directed towards a liquid detergent composition comprising (A) at least one chelating agent selected from alkali metal salts of methyl glycine diacetate and glutamic acid diacetate, (B) at least one anionic surfactant according to the general formula (I) CₙH₂ₙ₊₁—O(CH₂CH₂O)ₓ—SO₃M (I) (C) at least one non-ionic surfactant according to the general formula (II), CₘH₂ₘ₊₁—O(AO)_{y}H (II) the weight ratio of all chelating agent (A) to all anionic surfactant (B) being in the range of from 1:1 to 1:8, with the integers being defined as follows: n being a number in the range of from 10 to 18, m being a number in the range of from 10 to 18, M being selected from alkali metals, AO being different or identical and selected from ethylene oxide, propylene oxide, and butylene oxide, x being a number in the range of from 1 to 5, y being different or identical and selected from numbers in the range of from 1 to 12.

The present invention is directed towards a liquid detergent composition comprising
(A) at least one chelating agent selected from alkali metal salts of methyl glycine diacetate and glutamic acid diacetate,
(B) at least one anionic surfactant according to the general formula (I)

CₙH₂ₙ₊₁—O(CH₂CH₂O)ₓ—SO₃M (I)
(C) at least one non-ionic surfactant according to the general formula (II),

CₘH₂ₘ₊₁—O(AO)_{y}H (II)

the weight ratio of all chelating agent (A) to all anionic surfactant (B) being in the range of from 1:1 to 1:8,

with the integers being defined as follows:
n being a number in the range of from 10 to 18,
m being a number in the range of from 10 to 18,
M being selected from alkali metals,
AO being different or identical and selected from ethylene oxide, propylene oxide, and butylene oxide,
x being a number in the range of from 1 to 5,
y being different or identical and selected from numbers in the range of from 1 to 12.

Furthermore, the present invention is directed towards a method for making liquid detergent compositions, and to the use of such liquid detergent compositions as or for making a liquid laundry care composition.

Liquid laundry detergents have numerous benefits. The most common advantage over powder detergents is that they leave no residues on the clothes that may affect the appearance, in particular in the case of dark clothes. Such residues may also adversely affect membranes of clothes such as Gore-Tex®. Most of such residues found when using powder detergents mainly consist of bleaching agents and zeolites. For that reason, liquid laundry detergents are advantageously used for laundering colored clothes. Further advantages of liquid laundry detergents are that they are dispensed easily, and they readily dissolve in the washing liquor. With detergent powders, a common disadvantage is that they tend to caking when exposed to humidity. That disadvantage can be avoided when using liquid laundry detergents.

The removal of stains from soiled laundry is often referred to as primary detergency. Many liquid laundry detergents show a reduced ability to remove stains from colored soilings such as, but not limited to red wine, tea, coffee, vegetables, and various fruit juices like berry juices. Adding a bleaching agent would improve the ability of liquid laundry detergents to remove bleachable stains but deteriorate the detergent in aspects other than the ones discussed before. In particular, many bleaching agents are incompatible with certain surfactants, and they may lead to deterioration or degradation of enzymes.

It is therefore an objective to provide a liquid laundry detergent that has a good primary detergency. In particular, it is an objective to provide a liquid laundry detergent that has a good ability to remove bleachable stains such as red wine, tea, coffee, vegetables, and fruit juices. It is also an objective of the present invention to provide a process for manufacturing such liquid laundry detergents.

Accordingly, the liquid detergent compositions defined at the outset were found, hereinafter also referred to as inventive detergent compositions or inventive liquid detergent compositions or liquid detergent compositions according to the present invention.

Inventive detergent compositions are liquid. This property refers to normal conditions (25° C., one atmosphere). They appear clear or lightly opaque to the naked eye, and they can be poured like water. In the context of the present invention, gel-type liquid laundry detergents are a special embodiment of liquid laundry detergents. Gel-type liquid laundry detergents usually contain at least one viscosity modifier, and they contain little or no non-aqueous solvents. Gel-type liquid laundry detergents can be directly applied to stains in soiled laundry.

In one embodiment of the present invention, liquid detergent compositions according to the present invention have a dynamic viscosity in the range of from 500 to 20,000 mPa·s, determined at 25° C. according to Brookfield, for example spindle 3 at 20 rpm with a Brookfield viscosimeter LVT-II.

In one embodiment of the present invention, liquid detergent compositions according to the present invention may have a water content in the range of from 50 to 98% by weight, preferably up to 95%.

In one embodiment of the present invention, liquid detergent compositions according to the present invention may have a total solids content in the range of from 2 to 50% by weight, preferably 10 to 35% by weight.

In one embodiment of the present invention, liquid detergent compositions according to the present invention may comprise solvents other than water, for example ethanol, n-propanol, iso-propanol, n-butanol, iso-butanol, sec.-butanol, ethylene glycol, propylene glycol, 1,3-propane diol, butane diol, glycerol, diglycol, propyl diglycol, butyl diglycol, hexylene glycol, ethylene glycol methyl ether, ethylene glycol ethyl ether, ethylene glycol propyl ether, and phenoxyethanol, preferred are ethanol, isopropanol or propylene glycol.

In one embodiment of the present invention, liquid detergent compositions according to the present invention comprise 0.5 to 12% by weight of organic solvent, referring to the total respective liquid detergent composition. In embodiments in which inventive liquid detergent composition is provided as unit dose, e.g., in form of a pouch, the content of organic solvent may be in the range of from 8 to 25% by weight, referring to the total respective liquid detergent composition.

Inventive liquid detergent compositions contain
(A) at least one chelating agent selected from alkali metal salts of methyl glycine diacetate (MGDA) and glutamic acid diacetate (GLDA), hereinafter generally also being referred to as complexing agent (A).

In the context of the present invention, alkali metal salts of methylglycine diacetic acid are selected from lithium salts, potassium salts and preferably sodium salts of methylglycine diacetic acid. Methylglycine diacetic acid can be partially or preferably fully neutralized with the respective alkali. In a preferred embodiment, an average of from 2.7 to 3 COOH groups of MGDA is neutralized with alkali metal, preferably with sodium. In a particularly preferred embodiment, chelating agent (A) is the trisodium salt of MGDA.

Likewise, alkali metal salts of glutamic acid diacetic acid are selected from lithium salts, potassium salts and preferably sodium salts of glutamic acid diacetic acid. Glutamic acid diacetic acid can be partially or preferably fully neutralized with the respective alkali. In a preferred embodiment, an average of from 3.5 to 4 COOH groups of MGDA is neutralized with alkali metal, preferably with sodium. In a particularly preferred embodiment, chelating agent (A) is the tetrasodium salt of GLDA.

In one embodiment of the present invention, alkali metal salts of MGDA are selected from those of general formula (III)

[CH₃—CH(COO)—N(CH₂—COO)₂]Na_{3-a-y}KₐH_{b} (III)
a being selected from 0.0 to 0.5, preferably up to 0.25,
b being selected from 0.0 to 0.5, preferably up to 0.25.

In one embodiment of the present invention, alkali metal salts of GLDA are selected from those of general formula (IV)

[OCC—(CH₂)₂—CH(COO)—N(CH₂—COO)₂]Na_{4-a-y}KₐH_{b} (IV)
a being selected from 0.0 to 0.5, preferably up to 0.25,
b being selected from 0.0 to 0.5, preferably up to 0.25.

MGDA and its respective alkali metal salts can be selected from the racemic mixtures, the D-isomers and the L-isomers, and from mixtures of the D- and L-isomers other than the racemic mixtures. Preferably, MGDA and its respective alkali metal salts are selected from the racemic mixture and from mixtures containing in the range of from 55 to 85 mole-% of the L-isomer, the balance being D-isomer. Particularly preferred are mixtures containing in the range of from 60 to 80 mole-% of the L-isomer, the balance being D-isomer.

The distribution of L- and D-enantiomer can be determined by measuring the polarization (polarimetry) or preferably by chromatography, for example by HPLC with a chiral column, for example with one or more cyclodextrins as immobilized phase. Preferred is determination of the ee by HPLC with an immobilized optically active ammonium salt such as D-penicillamine.

GLDA and its respective alkali metal salts can be selected from the racemic mixtures, the D-isomers and the L-isomers, and from mixtures of the D- and L-isomers other than the racemic mixtures. Preferably, GLDA and its respective alkali metal salts are selected from mixtures containing in the range of from 75 to 99 mole-% of the L-isomer, the balance being D-isomer. Particularly preferred are mixtures containing in the range of from 80 to 97.5 mole-% of the L-isomer, the balance being D-isomer.

In any way, minor amounts of chelating agent (A) may bear a cation other than alkali metal. It is thus possible that minor amounts, such as 0.01 to 5 mol-% of total chelating agent (A) bear alkali earth metal cations such as Mg²⁺ or Ca²+, or an Fe²⁺ or Fe³⁺ cation.

In one embodiment of the present invention, chelating agent (A) is selected from the trisodium salt of methyl glycine diacetate and the tetrasodium salt of glutamic acid diacetate.

In a special embodiment, inventive liquid detergent compositions may contain a mixture from the sodium salts of MGDA and GLDA.

Inventive liquid detergent compositions contain
(B) at least one anionic surfactant according to the general formula (I)

CₙH₂ₙ₊₁—O(CH₂CH₂O)ₓ—SO₃M (I)

hereinafter also being referred to as surfactant (B) or anionic surfactant (B), with the integers being defined as follows:
n being a number in the range of from 10 to 18, preferably 12 to 14, and even more preferably n=12,
x being a number in the range of from 1 to 5, preferably 2 to 4 and even more preferably 3.
M being selected from alkali metals, preferably potassium and even more preferably sodium.

In surfactant (B), the integers n and x may be average numbers and therefore they are not necessarily whole numbers, while in individual molecules according to formula (I), both n and x denote whole numbers.

Inventive liquid detergent compositions further contain
(C) at least one non-ionic surfactant according to the general formula (II),

CₘH₂ₘ₊₁—O(AO)_{y}H (II)

hereinafter also being referred to as surfactant (C) or non-ionic surfactant (C),

with the integers being defined as follows:
m being a number in the range of from 10 to 18, preferably 16 to 18,
M being selected from alkali metals, preferably potassium and even more preferably sodium,
AO being different or identical and selected from ethylene oxide, propylene oxide, and butylene oxide, especially ethylene oxide, CH₂CH₂O,
y being different or identical and selected from numbers in the range of from 1 to 12, preferably 5 to 10.

In surfactant (C), the integers m and y may be average numbers and therefore they are not necessarily whole numbers, while in individual molecules according to formula (II), both m and y denote whole numbers.

The weight ratio of all chelating agent (A) to all anionic surfactant (B) is in the range of from 1:1 to 1:8, preferably from 1:1.5 to 1:4.

In one embodiment of the present invention, inventive liquid detergent compositions have a pH value in the range of from 7 to 9.5, preferably 8 to 9.

In one embodiment of the present invention inventive liquid detergent compositions comprise
(A) in the range of from 5 to 15% by weight of chelating agent, preferably 6 to 12% by weight,
(B) in the range of from 10 to 40% by weight of anionic surfactant, preferably 10 to 35% by weight, and
(C) in the range of from 5 to 40% by weight of non-ionic surfactant, preferably 8 to 30% by weight,
   percentages referring to the total solids content of said liquid detergent composition.

In one embodiment of the present invention inventive liquid detergent compositions said liquid laundry care compositions are free from bleaching agents. Bleaching agents in the context of the present invention are organic peroxides, inorganic peroxides and chlorine bleaches. Examples of organic and inorganic peroxides are sodium perborate, anhydrous or for example as monohydrate or as tetrahydrate or so-called dihydrate, sodium percarbonate, anhydrous or, for example, as monohydrate, hydrogen peroxide, persulfates, organic peracids such as peroxylauric acid, peroxystearic acid, peroxy-α-naphthoic acid, 1,12-diperoxydodecanedioic acid, perbenzoic acid, peroxylauric acid, 1,9-diperoxyazelaic acid, diperoxyisophthalic acid, in each case as free acid or as alkali metal salt, in particular as sodium salt, also sulfonylperoxy acids and cationic peroxy acids. chlorine-containing bleaches are, for example, 1,3-dichloro-5,5-dimethyl-hydantoin, N-N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

“Free from” in the context of bleaching agents means less than 0.5% by weight, referring to the total solids content.

In one embodiment of the present invention inventive liquid detergent compositions contain at least one alkali metal salt, preferably at least one potassium salt of a fatty acid. Examples are the sodium salts and especially the potassium salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid. Preferred examples are potassium coconut soap, potassium stearate, potassium oleate, potassium coconut soap with an average formula of n-C₁₂H₂₅COOK being even more preferred. The amount of potassium salt of fatty acid may be in the range of from 10 to 25% by weight referring to the total solids content of said liquid detergent composition.

In one embodiment of the present invention inventive liquid detergent compositions comprise linear sodium dodecylbenzenesulphonate, for example a mixture from the sodium salts of linear 4-dodecylbenzenesulphonate and linear 5-dodecylbenzenesulphonate. The amount of linear sodium dodecylbenzenesulphonate may be in the range of from 10 to 40% by weight referring to the total solids content of said liquid detergent composition.

Inventive liquid detergent compositions are liquid laundry detergent compositions. They may comprise ingredients other than the aforementioned. Examples are fragrances, dyestuffs, biocides, preservatives, enzymes, hydrotropes, builders, viscosity modifiers, polymers, buffers, defoamers, and anti-corrosion additives.

Examples of fragrances are benzyl salicylate, 2-(4-tert.-butylphenyl) 2-methylpropional, commercially available as Lilial®, and hexyl cinnamaldehyde.

Examples of dyestuffs are Acid Blue 9, Acid Yellow 3, Acid Yellow 23, Acid Yellow 73, Pigment Yellow 101, Acid Green 1, Solvent Green 7, and Acid Green 25.

Inventive liquid detergent compositions may contain one or more preservatives or biocides. Biocides and preservatives prevent alterations of inventive liquid detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (“MIT”) and 5-chloro-2-methyl-2H-isothiazol-3-one (“CIT”), benzoic acid, sorbic acid, iodopropynyl butylcarbamate (“IPBC”), dichlorodimethylhydantoine (“DCDMH”), bromochlorodimethylhydantoine (“BCDMH”), and dibromodimethylhydantoine (“DBDMH”).

Examples of viscosity modifiers are agar-agar, carragene, tragacanth, gum arabic, alginates, pectins, hydroxyethyl cellulose, hydroxypropyl cellulose, starch, gelatin, locust bean gum, cross-linked poly(meth)acrylates, for example polyacrylic acid cross-linked with methylene bis-(meth)acrylamide, furthermore silicic acid, clay such as—but not limited to—montmorrilionite, zeolite, dextrin, and casein.

Hydrotropes in the context with the present invention are compounds that facilitate the dissolution of compounds that exhibit limited solubility in water. Examples of hydrotropes are organic solvents such as ethanol, isopropanol, ethylene glycol, 1,2-propylene glycol, and further organic solvents that are water-miscible under normal conditions without limitation. Further examples of suitable hydrotropes are the sodium salts of toluene sulfonic acid, of xylene sulfonic acid, and of cumene sulfonic acid.

Examples of of useful enzymes are lipases, hydrolases, amylases, proteases, cellulases, hemi-cellulases, lipases, phospholipases, esterases, pectinases, lactases and peroxidases, and combinations of at least two of the foregoing types of the foregoing. Particularly useful enzymes are selected from are proteases, amylases, and cellulases.

Examples of polymers are especially polyacrylic acid and its respective alkali metal salts, especially its sodium salt. A suitable polymer is in particular polyacrylic acid, preferably with an average molecular weight M_{w} in the range from 2,000 to 40,000 g/mol. preferably 2,000 to 10,000 g/mol, in particular 3,000 to 8,000 g/mol, each partially or fully neutralized with alkali, especially with sodium. Also of suitability are copolymeric polycarboxylates, in particular those of acrylic acid with methacrylic acid and of acrylic acid or methacrylic acid with maleic acid and/or fumaric acid. Polyacrylic acid and its respective alkali metal salts may serve as soil anti-redeposition agents.

Further examples of polymers are polyvinylpyrrolidones (PVP). Polyvinylpyrrolidones may serve as dye transfer inhibitors.

Further examples of polymers are polyethylene terephthalates, polyoxyethylene terphthalates, and polyethylene terephthalates that are end-capped with one or two hydrophilic groups per molecule, hydrophilic groups being selected from CH₂CH₂CH₂—SO₃Na, CH₂CH(CH₂—SO₃Na)₂, and CH₂CH(CH₂SO₂Na)CH₂—SO₃Na.

Examples of buffers are monoethanolamine and N,N,N-triethanolamine.

Examples of defoamers are silicones.

Inventive liquid detergent compositions are not only good in cleaning soiled laundry with respect to inorganic soil such as clay, or organic fatty soil such as oil. Inventive liquid detergent compositions are very useful for removing non-bleachable stains such as, but not limited to stains from red wine, tea, coffee, vegetables, and various fruit juices like berry juices from laundry. They still do not leave residues on the clothes.

In order to be suitable as liquid laundry detergent inventive liquid detergent compositions may be in bulk form or as unit doses, for example in the form of sachets or pouches. Suitable materials for pouches are water-soluble polymers such as polyvinyl alcohol.

Another aspect of the present invention is the use of an inventive liquid detergent composition for cleaning laundry. Particularly, an aspect of the present invention is the use of inventive liquid detergent compositions for cleaning laundry stained with at least one of red wine, tea, coffee, vegetables, or fruit juice. Particularly important examples of fruit juices are apple juice, blueberry juice and blackberry juice. Another aspect of the present invention is a process to clean laundry, hereinafter also referred to as inventive process. The inventive process is directed towards cleaning laundry stained with bleachable stains such as at least one of red wine, tea, coffee, vegetables, or fruit juice such as, but not limited to apple juice, blueberry juice or blackberry juice by applying at least one inventive liquid detergent composition. The inventive process can be performed in an automatic laundry cleaner or manually. Said inventive detergent composition is preferably diluted with water before applying it to the soiled laundry.

In one embodiment of the present invention the inventive process is characterized in that the respective inventive liquid detergent composition is being applied to soiled laundry at a temperature in the range of from 20 to 65° C.

By the inventive process and according to the inventive use as well—such bleachable stains can be removed very efficiently.

A further aspect of the present invention is a process for making inventive liquid detergent compositions, hereinafter also referred to as inventive method. The inventive method comprises mixing chelating agent (A), surfactant (B) and surfactant (C), and, optionally, further ingredients as outlined above, with water in one or more steps.

The present invention is further illustrated by working examples.

The present invention is further illustrated by working examples. The wash performance of formulations F.1, F.2 and F.3 was determined and compared to the formulation without MGDA (V.1). Composition of the formulations is given in table 1. The washing conditions are illustrated in table 2. The respective formulations were made as follows:

A vessel was charged with 120 ml of water. Anionic surfactant 2 according to Table 1 and 1,2-propylene glycol—amount: 6% by weight referring to the total solids content were added and the resultant mixture was heated to 50-55° C. under stirring. The pH value was adjusted to 3 to 4 with aqueous potassium hydroxide solution (50%) and potassium coconut soap was added. Chelating agent (A.1) was added to the mixture so obtained, and the pH value was adjusted to 8.5 with aqueous potassium hydroxide solution (50%). Surfactant (B.1) and surfactant (C.1) were added. Ethanol—amount: 2% by weight referring to the total solids content—was added. Then the balance of water was added, and the resultant formulation was allowed to cool down to room temperature.

TABLE 1
Inventive liquid detergent compositions and
comparative liquid detergent compositions

| Ingredient [% of solids] | V.1 | F.1 | F.2 | F.3 |
|---|---|---|---|---|
| (A.1) | 0 | 10.1 | 6.7 | 9.5 |
| (B.1) | 20.2 | 18.2 | 11.8 | 34.5 |
| (C.1) | 20.2 | 18.2 | 19.3 | 9.4 |
| Anionic surfactant 2 | 20.6 | 18.5 | 27.6 | 34.5 |
| coconut soap, K salt | 9 | 8.1 | 8.1 | 7.6 |
| pH value | 8.5 | 8.5 | 8.5 | 8.5 |
| Total solids content (%) | 26.7 | 29.7 | 29.7 | 23.8 |

All amounts in g/100 g of solids content of the respective formulation.

Explanations to ingredients:
(A.1): MGDA, trisodium salt
(B.1): n-C₁₂H₂₅—O—(CH₂CH₂O)₃—SO₃Na
(C.1): n-C₁₈H₃₇—O(CH₂CH₂O)₇—H
Anionic surfactant 2: sodium salt of linear dodecylbenzenesulphonate

The washing conditions may be summarized as follows:

| | Launder-O-Meter+ from SDL Atlas, Rock | |
|---|---|---|
| Device | Hill, USA | |
| Washing liquor | 250 | mL |
| Washing time | 20 | minutes |
| Washing temperature | 40° C. | |
| Detergent concentration | 5.0 | g/L |
| Water hardness | 2.5 | mmol/L; |

| | |
|---|---|
| | Ca:Mg:HCO3 4:1:8 |
| Fabric to liquor ratio | 1:12.5 |
| Washing cycles* | 1 per type of soiled fabrics |
| Soiled fabrics | 4 fabrics of 2.5 g wfk 10J tee on cotton (fab- |
| | rics from WFK Testgewebe GmbH, |
| | Brueggen, Germany) |
| | 3 fabrics of 3.5 g Warwick 126 KC red wine |
| | on knitted cotton |
| | 3 fabrics of 3.5 g Warwick 023KC blueberry |
| | on knitted cotton |
| | 3 fabrics of 3.5 g Warwick 114KC strawberry |
| | on knitted cotton |
| | (fabrics from Warwick Chemicals, Consett, |
| | County Durham, DH8 6BN, England) |
| Ballast fabrics | 4 fabrics of BW 283 |

After the one cycle, soiled fabrics were rinsed with water, followed by shortly spin-drying and drying at room temperature over a period of 12 hours.

To evaluate the primary detergency of different bleachable stains, the degree of whiteness of the different soiled fabrics was determined before and after washing (delta reflectance values are shown in Table 3 using a sphere reflectance spectrometer (SF 500 type from Datacolor, USA, wavelength range 360-700 nm, optical geometry d/8°) with a UV cut-off filter at 460 nm. For obtaining the reflectance values for the respective fabric both before and after washing, an average of 6 different measuring points were taken each before and after washing. Higher delta reflectance values demonstrate a better primary detergency.

TABLE 3
Launder-O-meter washing performance results

| | wfk | Warwick | Warwick | Warwick |
|---|---|---|---|---|
| Formulation | 10J | 126KC | 023KC | 114KC |
| V.1 | 8 | 28.6 | 31.8 | 38.5 |
| F.1 | 10.6 | 31.2 | 34.1 | 40.7 |
| F.2 | 12.2 | 32.4 | 36.3 | 41.8 |
| F.3 | 12.5 | 33.0 | 37.7 | 42.8 |

All values are delta reflectance values.

If the delta reflectance value difference of the formulations according to the present invention (F.1, F.2, F.3) with respect to the comparative formulation (V.1) is bigger than 2 then the washing performance of the corresponding bleachable soiled fabrics has been clearly improved.

It can be seen that with the addition of MGDA (A.1), where the weight ratio of (A.1) to (B.1) is in the range of from 1:1 to 1:8, the washing performance of the bleachable stains can be improved significantly. An additional performance increase can be accomplished by decreasing the weight ratio of (A.1) to [(B.1)+anionic surfactant 2].

1. A liquid detergent composition, comprising:
(A) at least one chelating agent selected from the group consisting of an alkali metal salt of methyl glycine diacetate and an alkali metal salt of glutamic acid diacetate;
(B) at least one anionic surfactant having the formula (I),
CₙH₂ₙ₊₁—O(CH₂CH₂O)ₓ—SO₃M (I); and
(C) at least one non-ionic surfactant having the formula (II),
CₘH₂ₘ₊₁—O(AO)_{y}H (II)
wherein a weight ratio of all chelating agent (A) to all anionic surfactant (B) is in a range of from 1:1 to 1:8,
a total solid content of said liquid detergent composition is in a range of from 2 to 50% by weight,
n is an integer in a range of from 10 to 18,
m is an integer in a range of from 10 to 18,
M is an alkali metal,
AO is different or identical and is ethylene oxide, propylene oxide, or butylene oxide,
x is an integer in a range of from 1 to 5, and
y is different or identical and is an integer in a range of from 1 to 12.

2. The liquid detergent composition according to claim 1, wherein said liquid detergent composition is a liquid laundry detergent.

3. The liquid detergent composition according to claim 1, wherein the chelating agent (A) is selected from the group consisting of a trisodium salt of methyl glycine diacetate and a tetrasodium salt of glutamic acid diacetate.

4. The liquid detergent composition according to claim 1, wherein M in formula (I) is sodium.

5. The liquid detergent composition according to claim 1, wherein said liquid detergent composition comprises
in a range of from 5 to 15% by weight of the chelating agent (A),
in a range of from 10 to 40% by weight of the anionic surfactant (B), and
in a range of from 5 to 40% by weight of the non-ionic surfactant (C), based on the total solid content of said liquid detergent composition.

6. The liquid detergent composition according to claim 1, wherein n is 12.

7. The liquid detergent composition according to claim 1, wherein said liquid detergent composition is free from a bleaching agent.

8. The liquid detergent composition according to claim 1, wherein the liquid detergent composition contains at least one potassium salt of a fatty acid.

9. The liquid detergent composition according to claim 1, wherein said liquid detergent composition comprises linear sodium dodecylbenzenesulphonate.

10. A process to clean laundry stained with at least one of red wine, tea, coffee, vegetables, and fruit juice, the process comprising:
applying the liquid detergent composition according to claim 1 to the laundry.

11. The process according to claim 10, wherein said liquid detergent composition is applied to soiled laundry at a temperature in a range of from 20 to 65° C.

12-13. (canceled)

14. A process for making a liquid detergent composition according to claim 1, the process comprising:
mixing the components (A), (B) and (C).

15. The liquid detergent composition according to claim 1, wherein said liquid detergent composition has a dynamic viscosity in a range of from 500 to 20,000 mPa·s.

16. The liquid detergent composition according to claim 1, wherein said liquid detergent composition comprises
in a range of from 6 to 12% by weight of the chelating agent (A),
in a range of from 10 to 35% by weight of the anionic surfactant (B), and
in a range of from 8 to 30% by weight of the non-ionic surfactant (C),
based on the total solid content of said liquid detergent composition.
